(19) United States
(12) Patent Application Publication
(10) Pub. No.: US 2023/0089025 A1
(43) Pub. Date: Mar. 23, 2023

(54) REAL ESTATE PROPERTY ANALYSIS SYSTEM AND METHOD

(71) Applicants: Hannah Bomze, New York, NY (US); Erez Zarur, New York, NY (US)

(72) Inventors: Hannah Bomze, New York, NY (US); Erez Zarur, New York, NY (US)

(21) Appl. No.: 17/477,722

(22) Filed: Sep. 17, 2021

(51) Int. Cl. G06Q 50/16; G06Q 30/02; G06F 16/9535; G06N 20/00

(52) U.S. Cl. CPC G06Q 50/165; G06Q 30/0205; G06F 16/9535; G06N 20/00

(57) ABSTRACT

Disclosed embodiments provide a real estate property analysis system and method. A user provides search criteria, lifestyle options, and/or style preferences. This data is provided to a machine learning system to select real estate properties based on the provided information. The selected real estate property information is provided in a list to a user. The user interface enables positive or negative feedback of each of the items in the list. The machine learning system periodically adjusts the list based on user feedback. Thus, disclosed embodiments streamline and sort listings based on user preferences and lifestyle priorities, thereby introducing them to refined real estate property choices. Taking into account a user's unique style and lifestyle priorities, disclosed embodiments can provide a personalized feed of real estate property listings ranked such that the closest matches appear first in the list, thereby simplifying the complex task of searching for a home.

### FIELD

The present invention relates generally to computer systems, and more particularly to a real estate property analysis system and method.

### BACKGROUND

Purchasing a home is one of the most important decisions in many peoples lives. For many, it is also the largest purchase they ever make. Thus, careful consideration is warranted, and the search for homes can be a daunting and time-consuming process. While the internet has made some improvements in the ability to search for real estate properties online, the amount of information can still be excessive for many people to process. It is therefore desirable to have improvements in analyzing and searching for real estate properties.

### SUMMARY

In one embodiment, there is provided a computer-implemented method, comprising obtaining a plurality of lifestyle options; obtaining a region preference; obtaining a price range; obtaining a property type; and generating a list of properties based on the property type, region preference, price range, and the plurality of lifestyle options.

In another embodiment, there is provided an electronic computation device comprising: a processor; a memory coupled to the processor, the memory containing instructions, that when executed by the processor, cause the electronic computation device to: obtain a plurality of lifestyle options; obtain a region preference; obtain a price range; obtain a property type; and generate a list of properties based on the property type, region preference, price range, and the plurality of lifestyle options.

In yet another embodiment, there is provided a computer program product for an electronic computation device comprising a computer readable storage medium having program instructions embodied therewith, the program instructions executable by a processor to cause the electronic computation device to: obtain a plurality of lifestyle options; obtain a region preference; obtain a price range; obtain a property type; and generate a list of properties based on the property type, region preference, price range, and the plurality of lifestyle options.

### BRIEF DESCRIPTION OF THE DRAWINGS

The structure, operation, and advantages of the present invention will become further apparent upon consideration of the following description taken in conjunction with the accompanying figures (FIGs). The figures are intended to be illustrative, not limiting.

FIG. 1 is a flowchart indicating a process in accordance with embodiments of the present invention.

FIG. 2 illustrates a system for embodiments of the present invention.

FIG. 3 illustrates an exemplary user interface for obtaining lifestyle options in accordance with embodiments of the present invention.

FIG. 4 illustrates an exemplary user interface for obtaining style preferences in accordance with embodiments of the present invention.

FIG. 5 illustrates an exemplary user interface for obtaining search criteria in accordance with embodiments of the present invention.

FIG. 6 illustrates an exemplary user interface for displaying a property list in accordance with embodiments of the present invention.

FIG. 7 shows a block diagram for a client device in accordance with embodiments of the present invention.

FIG. 8 is a flowchart indicating a process in accordance with additional embodiments of the present invention.

FIG. 9 shows an exemplary criteria adjustment message in accordance with embodiments of the present invention.

FIG. 10 shows data structures in accordance with embodiments of the present invention.

FIG. 11 shows a diagram of a convolutional neural network (CNN) that may be used in embodiments of the present invention.

### DETAILED DESCRIPTION

Disclosed embodiments provide a real estate property analysis system and method. A user provides search criteria, lifestyle options, and/or style preferences. This data is provided to a machine learning system to select real estate properties based on the provided information. The selected real estate property information is provided in a list to a user. The user interface enables positive or negative feedback of each of the items in the list. In some embodiments, this may include swiping in one direction to provide positive feedback, and swiping in an opposite direction to provide negative feedback. The machine learning system periodically adjusts the list based on user feedback. Thus, disclosed embodiments streamline and sort listings based on user preferences and lifestyle priorities, thereby introducing them to refined real estate property choices. Disclosed embodiments enable selection of a sales agent directly from the listing user interface. This enables users to be guided through their real estate journey from beginning to end. Thus, disclosed embodiments, transcend simple criteria such as square footage and neighborhood. The machine learning of disclosed embodiments builds a search customized just for a specific user. Taking into account a user's unique style and lifestyle priorities, disclosed embodiments can provide a personalized feed of real estate property listings ranked such that the closest matches appear first in the list, thereby simplifying the complex task of searching for a home.

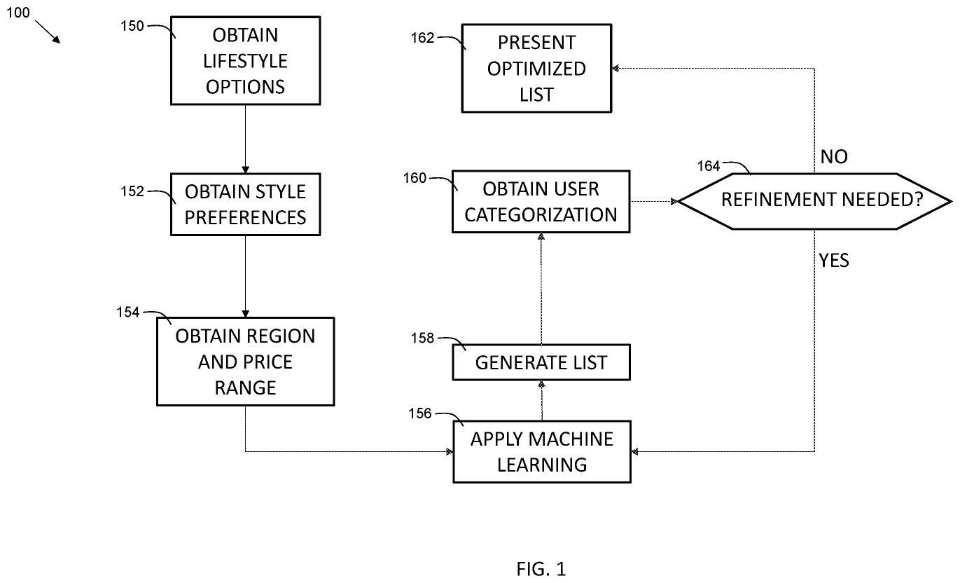

FIG. 1 is a flowchart 100 indicating a process in accordance with embodiments of the present invention. At 150, lifestyle options are obtained. This is a departure from other real estate applications that may ask only for structural and location requirements. Here, disclosed embodiments are going beyond that basic information to learn more about the user, to better tailor the results list of potential properties for purchase or rent. Lifestyle options can include elements such as cooking (how important cooking and kitchen features are to the user), household size (number of people living in the household), pets (number and/or type of pets), restaurants (how important it is for the user to live near restaurants), nightlife (how important it is for the user to live near clubs, theaters and other nightlife establishments), and/or retail (how important it is for the user to live near retail establishments). These criteria can be used to further refine search results.

At 152 style preferences are obtained. In embodiments, the style preferences are obtained by presenting a user with multiple images of various styles of décor. The user selects the images that he/she likes. The selected images are then provided to a machine learning system to identify other images associated with properties that share characteristics with the liked images. In some embodiments, the machine learning system may search through images associated with properties for rent and/or sale, and identify database records that contain images corresponding to properties for rent and/or sale that have similar traits

At 154, region and price range information are obtained. In embodiments, the region may be specified by a town name, state, ZIP code, and/or a distance range from a town, state, ZIP code, or other location. At 156, machine learning is applied to the data obtained in 150, 152, and 154. In embodiments, the machine learning can include, but is not limited to, a neural network, convolutional neural network (CNN), Decision Trees, Support Vector Machines, Random Forests, clustering, hierarchical clustering, k-means, and/or any other supervised learning techniques, unsupervised learning techniques, or a combination of both supervised and unsupervised learning techniques. In embodiments, TensorFlow or other suitable frameworks may be used in the implementation of machine learning systems used with disclosed embodiments.

In embodiments, the machine learning system may compute a numerical score for each property record, and rank the property records based on the numerical score. The numerical score may be a reflection of the closest match to the criteria established by the user, as well as matching of the style preferences that the user inputs by selecting images, and the lifestyle options that the user provides.

At 158 a list of real estate properties is generated. The list may be ranked based on the numerical score. At 160, a user categorization is obtained. In embodiments, the user categorization is a binary categorization having the possible values of a positive categorization or a negative categorization. In embodiments, a user applies a positive categorization to items from the list generated at 158 that they like. Similarly, the user applies a negative categorization to items from the list generated at 158 that they do not like. In embodiments, the user may apply a swipe on a touchscreen of an electronic device in a first direction (e.g., “swipe right”) to apply a positive categorization to an item in the list, and apply a swipe on a touchscreen of an electronic device in a second direction (e.g., “swipe left”) to apply a negative categorization to an item in the list. Instead of, or in addition to, swiping, a user interface may include buttons, such as a thumbs up button, for positive categorization, and a thumbs down button, for a negative categorization. In response to receiving a positive categorization, embodiments keep the property in the list, and update a property data record corresponding to the property to indicate a positive categorization for the property.

At 164 a check is made to determine if the review is complete, meaning that the user has applied a categorization to a predetermined number of items in the list. In some embodiments, the user may apply a categorization to all the items in the list. In some embodiments, the user may apply a categorization to a subset of items in the list (e.g., twenty percent of the items in the list). In embodiments, once the subset of items has had a categorization applied, the process continues to 164 to determine if further refinement is needed. In some embodiments, the criteria for refinement may include the number of items in the list. If the number of items in the list is above a predetermined threshold, then the process may continue back to 156, to apply machine learning and generate a revised list at 158, and then obtain user categorization on the revised list at 160. This process may continue until the list is refined sufficiently such that an optimized list is presented at 162. In this way, a user is provided with a list of real estate properties for rent and/or purchase that are derived based on machine learning analysis of user-provided style preferences and lifestyle options. Thus, embodiments can include a computer-implemented method, comprising obtaining a plurality of lifestyle options; obtaining a region preference; obtaining a price range; obtaining a property type; and generating a list of properties based on the property type, region preference, price range, and the plurality of lifestyle options.

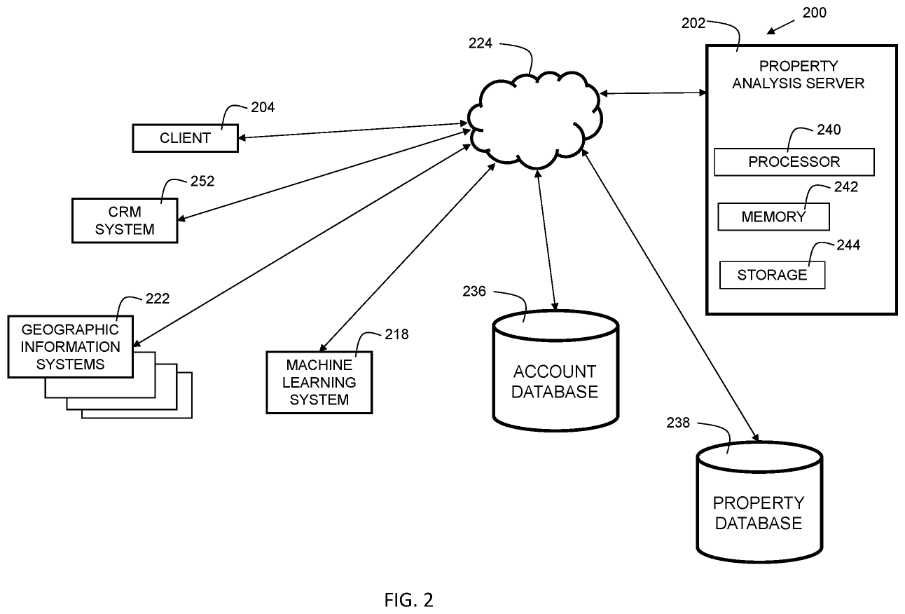

FIG. 2 illustrates a system 200 for embodiments of the present invention. System 200 includes a property analysis server 202. Property analysis server 202 is an electronic computation device. In embodiments, the property analysis server 202 is implemented as a computer comprising a processor 240, and memory 242 coupled to the processor. The memory 242 may be a non-transitory computer readable storage medium. Memory 242 may include RAM, ROM, flash, EEPROM, or other suitable storage technology. The memory 242 contains instructions, that when executed by processor 240, enable communication with a variety of other devices and data stores. In embodiments, network 224 may include the Internet.

Storage 244 may include one or more magnetic hard disk drives (HDD), solid state disk drives (SSD), optical storage devices, tape drives, and/or other suitable storage devices. In embodiments, storage 244 may include multiple hard disk drives configured in a RAID (redundant array of independent disks) configuration. In embodiments, the RAID configuration can include a RAID 1 configuration in which data is copied seamlessly and simultaneously, from one disk to another, creating a replica, or mirror. If one hard disk drive becomes inoperable, another hard disk drive continues to operate, providing a level of fault tolerance for use in embodiments that utilize local storage in managed onsite or off-site servers, cloud-based storage, or other suitable storage.

In some embodiments, the property analysis server 202 may be implemented as a virtual machine (VM), or scaled to be implemented on multiple virtual machines and/or containerized applications. In some embodiments, the virtual machines may be hosted in a cloud computing environment. In some embodiments, load balancing, and orchestration via a system such as Kubernetes, enables a scalable solution that can process video and sensor array data from multiple residences simultaneously.

A client device 204 is also connected to network 224. In embodiments, client device 204 may include, but is not limited to, a desktop computer, a laptop computer, a tablet computer, a mobile phone (e.g., smartphone), and/or other suitable electronic computing device. Note that while one client device 204 is shown in FIG. 2, in practice, multiple client devices may concurrently establish connections with property analysis server 202 in accordance with embodiments of the present invention. In embodiments, the client device 204 can be used to interact with the property analysis server 202, receive real estate property listing results, send messages, and/or other functionality.

The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet can be provided by Internet service providers (ISP). Users on client systems, such as client device 204 obtains access to the Internet through the Internet service providers. Access to the Internet allows users of the client computer systems to exchange information, receive and send e-mails, and view documents, such as documents which have been prepared in the HTML format. These documents are often provided by web servers which are considered to be “on” the Internet. Often these web servers are provided by the ISPs, although a computer system can be set up and connected to the Internet without that system being also an ISP as is well known in the art.

System 200 may further include an account database 236. The account database 236 may comprise multiple records, where each record includes entities such as seller records, buyer records, and event records (such as appointments to visit a property). The account database 236 may be implemented as a relational database, utilizing a Structured Query Language (SQL) format, or another suitable database format.

System 200 may further include a property database 238. The property database 238 may comprise multiple records, where each record includes entities such property records, images of properties, videos of properties, selling price of properties, rental rate for properties, and/or other metadata pertaining to real estate properties. The property database 238 may be implemented as a relational database, utilizing a Structured Query Language (SQL) format, or another suitable database format. In some embodiments, the property database 238 may include data from a variety of sources, such as a Multiple Listing Services (MLS) database.

System 200 may further include a CRM (customer relationship management) system 252. The CRM 242 may include an off-the shelf system, such as Salesforce, Zillow Premier Agent CRM, a custom-built CRM system, or other suitable system for managing contacts, appointments, and other data needed. This enables users to set up appointments and request more information pertaining to properties of interest to the user that are provided by the property analysis server 202

System 200 may further include a machine learning system 218. Machine learning system 218 may be used to further categorize and classify input data including data image data, scenery, object recognition and/or object classification, and/or other classification processes. Machine learning system 218 may include one or more neural networks, convolutional neural networks (CNNs), and/or other deep learning techniques.

The machine learning system 218 may include regression algorithms, classification algorithms, clustering techniques, anomaly detection techniques, Bayesian filtering, and/or other suitable techniques to analyze the information obtained by the property analysis server 202 to identify properties for sale/rent that a user may like. Thus, in embodiments, generating the list of properties is performed using machine learning.

In embodiments, the machine learning system 218 may be trained a priori, using multiple training data sets. The training data sets can include multiple images, videos, geographic data, meteorological data, and/or other suitable data. Embodiments may include an image preprocessing module that performs image manipulations such as contrast enhancement, noise filtering, edge enhancement, resizing, histogram equalization, rotation, translation, and/or other operation to improve the image data(features) by suppressing unwanted distortions and enhancement of some important image features so that the machine learning system 218 can benefit from this improved data. Data augmentation techniques may be applied to generate additional training images that are rotated, reflected, or otherwise transformed from the original images. In embodiments, the machine learning system 218 may undergo a validation process to assess that the training is sufficient.

System 200 may further one or more geographic information systems (GIS) 222. The geographic information systems (GIS) 222 may perform tasks such as identifying geographical and/or political boundaries, population density, cost of living information, tax rate data, and/or other criteria. In some embodiments, the property analysis server 202 can interface with the geographic information systems 222 via application programming interface (API) calls. Communication between the property analysis server 202 and the geographic information systems (GIS) 222 can include the use of protocols such as HTTP (HyperText Transfer Protocol), XML (Extensible Markup Language), JSON (JavaScript Object Notation), SOAP (Simple Object Access Protocol), RESTful APIs, and/or other suitable technologies. The property analysis server 202 may include and/or utilize multiple computer systems, databases, load balancers, and other infrastructure to support analysis of selections made by user via client 204.

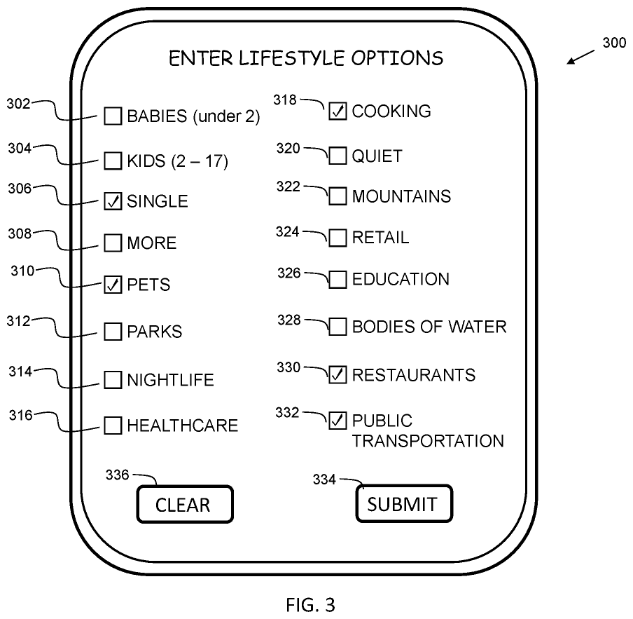

FIG. 3 illustrates an exemplary user interface 300 for obtaining lifestyle options in accordance with embodiments of the present invention. The lifestyle options shown in FIG. 3 are used in some embodiments. Other embodiments may use more, fewer, and/or different lifestyle options. At 302 an option for babies is presented. A user may select this option if they have children under two years of age. At 304 an option for kids (children) is presented. A user may select this option if they have children between the ages of two to 17. At 306 an option for “single” is presented. A user may select this option if they live alone. At 308 an option for “more” (household size) is presented. A user may select this option if there is more than one person living in the household. In some embodiments, the user may be able to enter a numeric value for a household size when this option is selected. At 310 an option for “pets” is presented. A user may select this option if they have pets, such as dogs, cats, birds, or the like. At 312 an option for “parks” is presented. A user may select this option if living in proximity to parks is an important consideration for the user. At 314 an option for “nightlife” is presented. A user may select this option if living in proximity to nightlife such as nightclubs and bars is an important consideration for the user. At 316 an option for “healthcare” is presented. A user may select this option if living in proximity to healthcare facilities such as a sizeable selection of doctors, hospitals, and/or medical clinics is an important consideration for the user. At 318 an option for “cooking” is presented. A user may select this option if they enjoy cooking, and/or cooking is important to them. This may be used to prioritize real estate properties having kitchens with certain features, and/or exceeding a predetermined area. At 320 an option for “quiet” is presented. A user may select this option if quiet surroundings is an important consideration for the user. This may be used to prioritize real estate properties located at least a predetermined distance from highways, factories, and/or other entities that are associated with excessive noise. At 322 an option for “mountains” is presented. A user may select this option if living in proximity to mountains is an important consideration for the user. At 324 an option for “retail” is presented. A user may select this option if living in proximity to retail establishments such as malls, shopping centers, and/or other retail establishments is an important consideration for the user. At 326 an option for “education” is presented. A user may select this option if living in proximity to a wide selection of school systems, colleges, universities, trade schools, and/or other educational institutions is an important consideration for the user. At 328 an option for “bodies of water” is presented. A user may select this option if living in proximity to bodies of water such as rivers, lakes, oceans, and/or other bodies of water is an important consideration for the user. At 330 an option for “restaurants” is presented. A user may select this option if living in proximity to a large concentration of restaurants and/or other eating establishments is an important consideration for the user. At 332 an option for “public transportation” is presented. A user may select this option if living in proximity to public transportation options such as busses, subways, trains, taxies, airports, and/or other public transportation is an important consideration for the user.

As shown in FIG. 3, the items at 306, 310, 318, 330, and 332 are selected, as indicated by a checkbox. In practice, another user interface technique can be used for selecting or deselecting lifestyle options. Thus, as shown in FIG. 3, in embodiments, the plurality of lifestyle options can include cooking (how important cooking and kitchen features are to the user), household size (number of people living in the household), pets (number and/or type of pets), restaurants (how important it is for the user to live near restaurants), nightlife (how important it is for the user to live near clubs, theaters and other nightlife establishments), and/or retail (how important it is for the user to live near retail establishments).

Embodiments may further include a “submit” button 334. Invoking the submit button causes a client device (e.g., 204 of FIG. 2) to send the lifestyle options selected by a user to the property analysis server 202 via network 224. Embodiments may further include a “clear” button 336. Invoking the submit button causes a client device (e.g., 204 of FIG. 2) to clear all the selected lifestyle options shown in user interface 300.

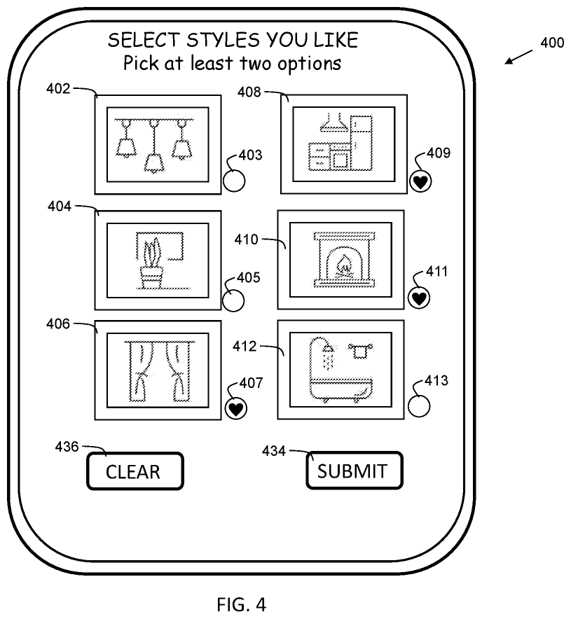

FIG. 4 illustrates an exemplary user interface 400 for obtaining style preferences in accordance with embodiments of the present invention. In embodiments, a user is presented with multiple images of styles, indicated as 402, 404, 406, 408, 410, and 412, and asked to select styles they like. In embodiments, the user may select styles by invoking a corresponding button. Button 403 corresponds to image 402. Button 405 corresponds to image 404. Button 407 corresponds to image 406. Button 409 corresponds to image 408. Button 411 corresponds to image 410. Button 413 corresponds to image 412. In the example of FIG. 4, the user has selected images 406, 408, and 410, as indicated by the heart icon in buttons 407, 409, and 411.

Embodiments may further include a “submit” button 434. Invoking the submit button causes a client device (e.g., 204 of FIG. 2) to send the style preferences selected by a user to the property analysis server 202 via network 224. Embodiments may further include a “clear” button 436. Invoking the clear button causes a client device (e.g., 204 of FIG. 2) to clear all the selected style preferences shown in user interface 400.

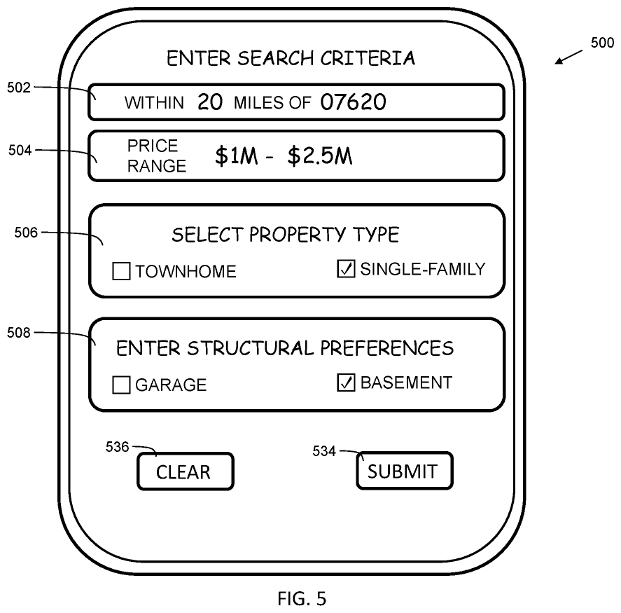

FIG. 5 illustrates an exemplary user interface 500 for obtaining search criteria in accordance with embodiments of the present invention. In field 502, a user selects a geographical region. In the example of FIG. 5, this includes selecting a distance from a user-supplied ZIP code. Other embodiments may include specifying of regions, such as counties or states. Other embodiments may include specification of latitude and longitude coordinates, or other suitable geolocation identifiers. In field 504, the user enters a desired price range for the purchase price of a real estate property. In some embodiments, the user enters a desired rental fee range for the rental of a real estate property. In field 506, a property type preference field is shown. In embodiments, a user may select one or more property types as preferred. In field 508, a structural preference field is shown. In embodiments, a user may select one or more structural preferences they prefer, such as a garage or a basement.

Embodiments may further include a “submit” button 534. Invoking the submit button causes a client device (e.g., 204 of FIG. 2) to send the search criteria selected by a user to the property analysis server 202 via network 224. Embodiments may further include a “clear” button 536. Invoking the clear button causes a client device (e.g., 204 of FIG. 2) to clear all the selected search criteria shown in user interface 500.

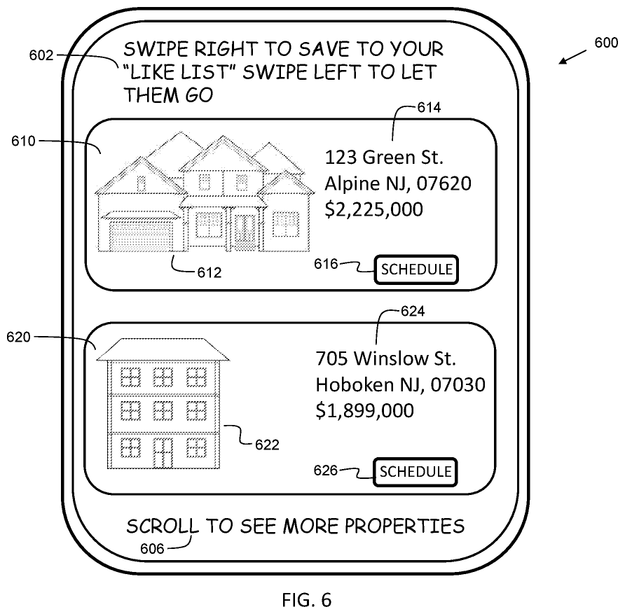

FIG. 6 illustrates an exemplary user interface 600 for displaying a real estate property list in accordance with embodiments of the present invention. Field 602 provides instructions for a user to provide a user categorization. In some embodiments, a user may “swipe” (e.g., make a relatively linear motion with a finger along a touchscreen of an electronic device) in a given direction to provide a user categorization. As shown in the example of FIG. 6, the user is instructed to swipe right to indicate a positive categorization, and save the real estate property record to a “like list,” favorites list, or other suitable list of real estate properties that are favorable to the user. Similarly, the user is instructed to swipe left to indicate a negative categorization, which indicates the real estate properties that are not favorable to the user. In embodiments, these real estate properties are removed from the list. In embodiments, the user categorizations for the real estate properties are provided to the machine learning system which then performs a search of additional real estate property records from the database 238 in order to find additional properties that the user may like.

A first real estate property listing is shown at 610. The listing 610 may include one or more images 612, metadata 614, and a schedule button 616. The metadata can include address, price, features, and/or other metadata pertaining to the real estate property. If the user is interested in learning more about the real estate property and/or setting up an appointment to visit the property, the user can invoke the schedule button 616, which sends a message to the CRM system 252, indicating the property and user information, such that a sales representative can contact the user to further explore the real estate property.

A second real estate property listing is shown at 620. The listing 620 may include one or more images 622, metadata 624, and a schedule button 626. The metadata can include address, price, features, and/or other metadata pertaining to the real estate property. If the user is interested in learning more about the real estate property and/or setting up an appointment to visit the property, the user can invoke the schedule button 626, which sends a message to the CRM system 252, indicating the property and user information, such that a sales representative can contact the user to further explore the real estate property.

In embodiments, a left swipe removes a real estate property listing from the list, while a right swipe preserves a real estate property listing in the list. As shown in text field 606, in embodiments, a user may scroll (e.g., up or down) to see additional real estate property listings. Once the user has reviewed the entire list and applied a user categorization (positive or negative), the remaining items in the list are all real estate property records pertaining to properties that are favorable to the user. The user can then give a second pass to these properties to further narrow down the list to properties he/she wishes to inquire about.

In some embodiments, instead of swiping, the user interface may provide two buttons, one to indicate a positive categorization, and another button to indicate a negative categorization. In some embodiments, a third button may be included to indicate a “maybe” categorization.

Embodiments can include receiving a categorization input from a user for a property from the list of properties; and in response to receiving a negative categorization, removing the property from the list. Embodiments can include receiving a schedule request message; and sending an appointment request to a customer relationship management system in response to receiving the schedule request message.

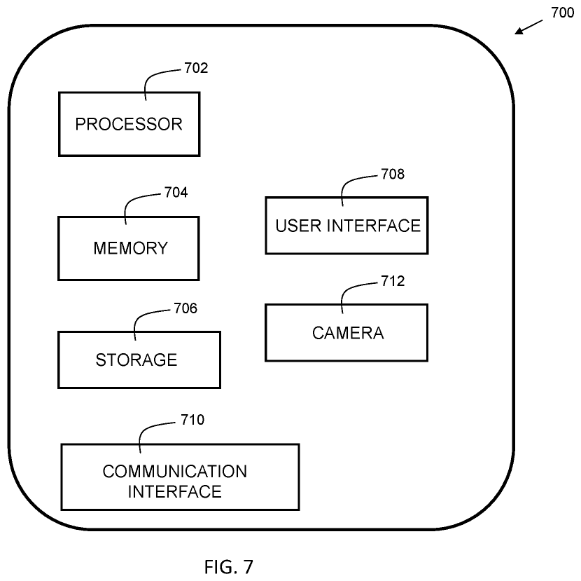

FIG. 7 is a block diagram of a client device 700 in accordance with embodiments of the present invention. In embodiments, client device 700 is an electronic device that may include a desktop computer, laptop computer, tablet computer, smartphone, and/or other suitable client device. Client device 700 may be similar to client device 204 as shown in FIG. 2. Client device 700 includes a processor 702, a memory 704 coupled to the processor 702, and storage 706. The memory 704 may be a non-transitory computer readable medium. Memory 704 may include RAM, ROM, flash, EEPROM, or other suitable storage technology. The memory 704 contains instructions, that when executed by processor 702, enable communication to/from property analysis server 202 of FIG. 2. Client device 700 further includes a network communication interface 710 for performing this communication. In embodiments, network communication interface 710 includes a wireless communications interface such as a cellular data interface and/or a Wi-Fi interface. In embodiments, the storage 706 includes flash, SRAM, one or more hard disk drives (HDDs) and/or solid-state drives (SSDs).

Device 700 may further include a user interface 708. User interface 708 may include a keyboard, monitor, mouse, and/or touchscreen, and provides a user with the ability to enter information as necessary to utilize embodiments of the present invention. In embodiments, a user uses the device 700 to access search results from a trained neural network and/or other machine learning system via the property analysis server 202 of FIG. 2. Device 700 further includes a camera 712. The camera 712 may record both video and audio, and may be used to enable voice and/or video communication between sales agents via CRM system 252.

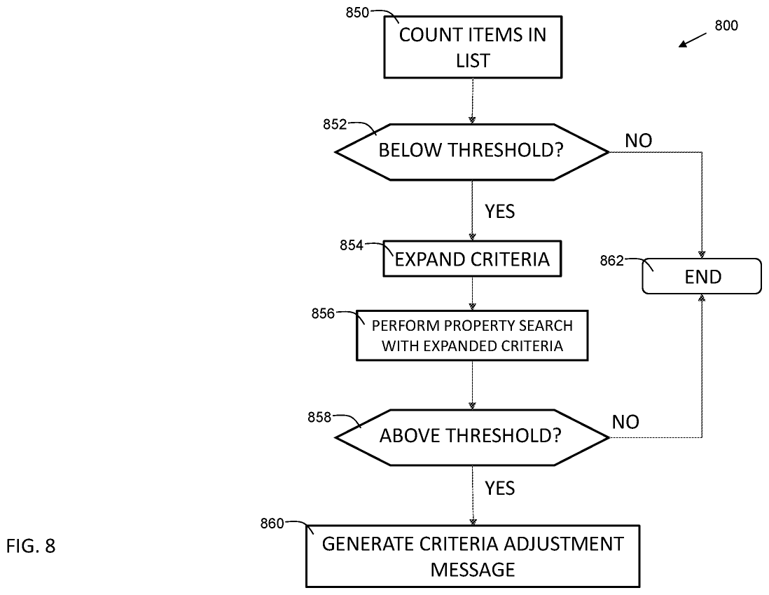

FIG. 8 is a flowchart 800 indicating a process in accordance with additional embodiments of the present invention. The flowchart of FIG. 8 shows steps for a feature of automatic criteria adjustment in accordance with embodiments of the present invention. At 850, a number of real estate property listings (items) within the list are counted. At 852, a check is made to determine if the number of items is below a predetermined threshold (e.g., below 20 listings). If no at 852, the process ends at 862. If yes at 852, then the process continues to 854, where the criteria is expanded. In embodiments, the criteria expansion can include increasing the maximum price by a predetermined factor (e.g., increasing the maximum price by ten percent, a fixed dollar amount increase, or other factor). In embodiments, the criteria expansion can also include increasing the distance range (see 502 of FIG. 5) by a predetermined factor (e.g., increasing the distance by ten percent, a fixed distance increase, or other factor).

At 856, a real estate property search is performed using the expanded criteria to create a revised list, and the number of items in the revised list is counted. If, at 858, the number of items in the revised list is still not above the predetermined threshold, then the process ends at 862. If yes at 858, then the process continues to 860, where a criteria adjustment message is generated. The criteria adjustment message can suggest criteria adjustments to a user to enable the user to get exposed to additional real estate property listings. This feature serves to remove guesswork and identify if it could be worthwhile for a user to expand the search criteria. If expanding the search criteria does not result in sufficiently more real estate property listings appearing in the search results list, then the user is not prompted for the suggestion to expand the criteria. If, however, expanding the search criteria does result in sufficiently more real estate property listings appearing in the search results list, then the user is prompted for the suggestion to expand the criteria.

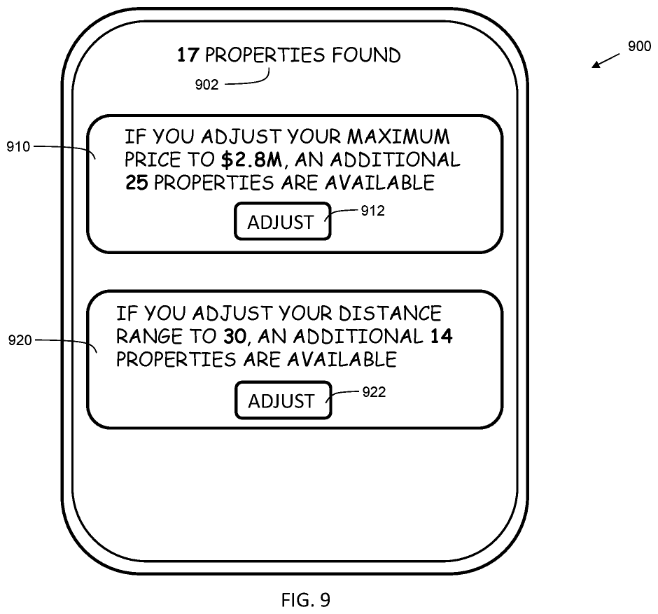

FIG. 9 shows a user interface 900 displaying an exemplary criteria adjustment message in accordance with embodiments of the present invention. At 902, a data field indicating the number of real estate properties currently found based on the search criteria is displayed. In the example, the data field 902 indicates 17 properties are found. For the purpose of this example, the original search criteria are that which is shown at 502 and 504 of FIG. 5. At 910, a first criteria adjustment message is shown, indicating that if the maximum price is raised from $2.5M (504 of FIG. 5) to $2.8M, then an additional 25 properties will be included in the search results. If the user wishes to accept this adjustment, the user invokes the “adjust” button 912, which causes the client device (e.g., 204 of FIG. 2) to send the adjusted search criteria to the property analysis server 202 via network 224 to create a revised real estate property list using the adjusted search criteria.

Similarly, at 920, a second criteria adjustment message is shown, indicating that if the distance range is increased from 20 miles (502 of FIG. 5) to 30 miles, then an additional 14 properties will be included in the search results. If the user wishes to accept this adjustment, the user invokes the “adjust” button 922, which causes the client device (e.g., 204 of FIG. 2) to send the adjusted search criteria to the property analysis server 202 via network 224 to create a revised real estate property list using the adjusted search criteria. In some embodiments, an automatic expansion of search criteria is performed when the original search criteria obtains a number of search results that is below a predetermined threshold.

Embodiments can include determining a number of property records in the list; in response to the number of property records in the list being at or below a predetermined threshold: performing a criteria expansion to obtain expanded criteria; performing a property search based on the expanded criteria to create a revised list; determining a number of property records in the revised list; and in response to the number of property records in the revised list exceeding a predetermined threshold: generating a criteria adjustment message; and sending the criteria adjustment message to a remote computing device.

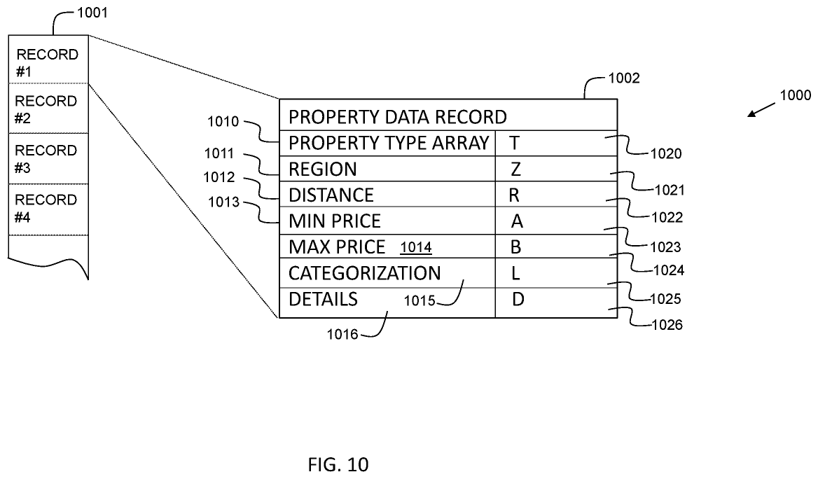

FIG. 10 shows a diagram 1000 of data structures in accordance with embodiments of the present invention. Real estate property records list 1001 may be a list of records retrieved based on search criteria, style preferences, and/or lifestyle options. In some embodiments, the real estate property records list 1001 may be ranked based on a numerical score computed by the property analysis server 202. Record #1 from list 1001 is shown in detail at 1002. Record #1 is a real estate property record. It includes a property type array 1010 having data T at 1020. The data T may be a tuple or array of data, a bit field, or other suitable data structure to include type information. The type information can include, but is not limited to, a structural type (e.g., single family, townhome, condominium, or other suitable type. The record 1002 includes a region field at 1011 having data Z at 1021. Data Z may be a tuple or array of data including region information. The region information can include a state, province, county, town, street address, latitude and longitude coordinates, block and lot numbers, and/or other suitable region information.

The record 1002 includes a distance field at 1012 having data R at 1022. Data R may be a value including distance information. The distance information can include a distance in miles, kilometers, or other suitable unit of measurement. In embodiments, the distance is used to establish a search area based on information in the region field 1011. As an example, embodiments may generate a circle having a radius determined by the distance value R, and a center established by information in the region field 1011, such as a street address or longitude and latitude coordinates of a real estate property.

The record 1002 includes a minimum price field at 1013 having data A at 1023. Data A may be a value including a minimum price in US dollars or other suitable currency. The minimum price may represent a lower limit for a selling price of a real estate property to be considered in search results for a user.

The record 1002 includes a maximum price field at 1014 having data B at 1024. Data B may be a value including a maximum price in US dollars or other suitable currency. The maximum price may represent an upper limit for a selling price of a real estate property to be considered in search results for a user.

The record 1002 includes a categorization field at 1015 having data L at 1025. Data L may be a Boolean value including a positive or negative categorization. The categorization may be used by the property analysis server 202 to determine if a real estate property is to remain in a list of real estate properties to be provided to a user.

The record 1002 includes a details field at 1016 having data Dat 1026. Data D may be an array, text field, XML file, and/or other suitable data structure for storing additional details regarding the real estate property. The details can include information such as number of bedrooms, bathrooms, dimensions of rooms, images, videos, repair records, government property records, and/or other relevant information.

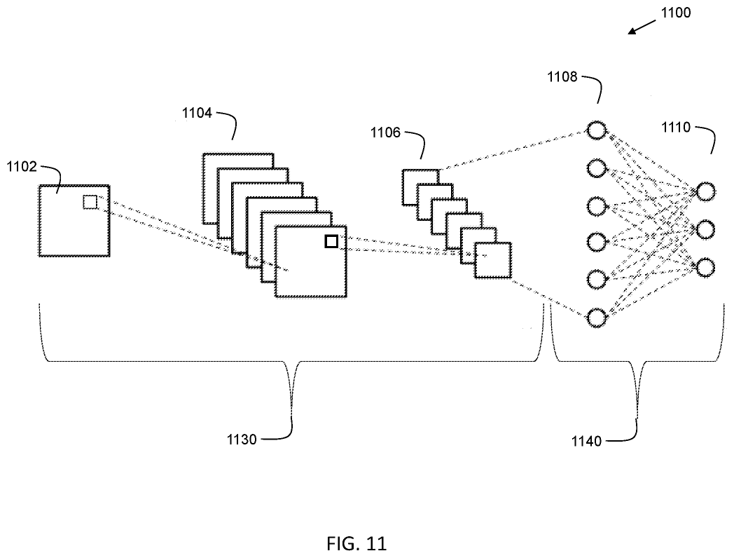

FIG. 11 shows a diagram 1100 of a convolutional neural network (CNN) that may be used in embodiments of the present invention. The CNN shown in FIG. 11 include an input layer 1102 which feeds into one or more convolution layers 1104. These layers feed into one or more pooling layers 1106. The pooling layers 1106 provide input to fully connected layers 1108, which in turn feed data to output layers 1110. Section 1130 of the CNN includes the input layer 1102, convolution layers 1104, and pooling layers 1106, and serves as a feature extraction portion of the CNN. Section 1140 of the CNN includes the fully connected layers 1108 and output layers 1110, convolution layers 1104, and pooling layers 1106, and serves as a feature extraction portion of the CNN.

In some embodiments utilizing a CNN, the CNN may include one or more convolutional layers, ReLU layers, pooling layers, and/or a fully connected layer. In embodiments, the CNN architecture may include the following configuration:

Input→Convolution→ReLU→Convolution→ReLU→Pooling→ReLU→Convolution→ReLU→Pooling→Fully Connected

Other CNN configurations are possible in disclosed embodiments.

As can now be appreciated, disclosed embodiments provide systems and methods suitable for both renters and buyers to use for their home search. A user can create a profile and then outline his/her preferences. Potential homes meeting the user criteria and/or preferences are rendered on an electronic communication device as a list of properties. Using machine learning techniques, the list of properties is refined over time based on user feedback to provide a customized list of real estate properties based on the output of a machine learning system.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A computer-implemented method, comprising
obtaining a plurality of lifestyle options;
obtaining a region preference;
obtaining a price range;
obtaining a property type; and
generating a list of properties based on the property type, region preference, price range, and the plurality of lifestyle options.

2. The method of claim 1, further comprising:
receiving a categorization input from a user for a property from the list of properties; and
in response to receiving a negative categorization, removing the property from the list.

3. The method of claim 2, further comprising, in response to receiving a positive categorization, keeping the property in the list, and updating a property record corresponding to the property to indicate a positive categorization for the property.

4. The method of claim 1, wherein the plurality of lifestyle options includes cooking.

5. The method of claim 1, wherein the plurality of lifestyle options includes household size.

6. The method of claim 1, wherein the plurality of lifestyle options includes pets.

7. The method of claim 1, wherein the plurality of lifestyle options includes restaurants.

8. The method of claim 1, wherein the plurality of lifestyle options includes nightlife.

9. The method of claim 1, wherein the plurality of lifestyle options includes retail.

10. The method of claim 1, wherein generating the list of properties is performed using machine learning.

11. The method of claim 1, further comprising:
determining a number of property records in the list;
in response to the number of property records in the list being at or below a predetermined threshold:
performing a criteria expansion to obtain expanded criteria;
performing a property search based on the expanded criteria to create a revised list;
determining a number of property records in the revised list; and
in response to the number of property records in the revised list exceeding a predetermined threshold:
generating a criteria adjustment message; and
sending the criteria adjustment message to a remote computing device.

12. The method of claim 10, further comprising:
receiving a schedule request message; and
sending an appointment request to a customer relationship management system in response to receiving the schedule request message.

13. An electronic computation device comprising:
a processor;
a memory coupled to the processor, the memory containing instructions, that when executed by the processor, cause the electronic computation device to:
obtain a plurality of lifestyle options;
obtain a region preference;
obtain a price range;
obtain a property type; and
generate a list of properties based on the property type, region preference, price range, and the plurality of lifestyle options.

14. The electronic computation device of claim 13, wherein the memory further includes instructions, that when executed by the processor, cause the electronic computation device to:
receive a categorization input from a user for a property from the list of properties; and
in response to receiving a negative categorization, remove the property from the list.

15. The electronic computation device of claim 14, wherein the memory further includes instructions, that when executed by the processor, cause the electronic computation device to: in response to receiving a positive categorization, keep the property in the list, and update a property data record corresponding to the property to indicate a positive categorization for the property.

16. The electronic computation device of claim 13, wherein the memory further includes instructions, that when executed by the processor, cause the electronic computation device to:
determine a number of property records in the list;
in response to the number of property records in the list being at or below a predetermined threshold:
perform a criteria expansion to obtain expanded criteria;
perform a property search based on the expanded criteria to create a revised list;
determine a number of property records in the revised list; and
in response to the number of property records in the revised list exceeding a predetermined threshold:
generate a criteria adjustment message; and
send the criteria adjustment message to a remote computing device.

17. The electronic computation device of claim 16, wherein the memory further includes instructions, that when executed by the processor, cause the electronic computation device to:
receive a schedule request message; and
send an appointment request to a customer relationship management system in response to receiving the schedule request message.

18. A computer program product for an electronic computation device comprising a computer readable storage medium having program instructions embodied therewith, the program instructions executable by a processor to cause the electronic computation device to:
obtain a plurality of lifestyle options;
obtain a region preference;
obtain a price range;
obtain a property type; and
generate a list of properties based on the property type, region preference, price range, and the plurality of lifestyle options.

19. The computer program product of claim 18, further including instructions, that when executed by the processor, cause the electronic computation device to:
receive a categorization input from a user for a property from the list of properties; and
in response to receiving a negative categorization, remove the property from the list.

20. The computer program product of claim 19, further including instructions, that when executed by the processor, cause the electronic computation device to:
in response to receiving a positive categorization, keep the property in the list, and
update a property data record corresponding to the property to indicate a positive categorization for the property.
